(19) United States
(12) Patent Application Publication
(10) Pub. No.: US 2009/0016696 A1
(43) Pub. Date: Jan. 15, 2009

(54) Audio/Video Playback Method for a Multimedia Interactive Mechanism and Related Apparatus using the same

(76) Inventors: Ming-Kai Hsieh, Taipei City (TW); Pei-Hsuan Tu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/014,105

(22) Filed: Jan. 15, 2008

(30) Foreign Application Priority Data
Jul. 9, 2007 (TW) 096124954

(51) Int. Cl. H04N 7/26

(52) U.S. Cl. 386/124

(57) ABSTRACT

An AV playback method for an interactive mechanism includes generating a designated file comprising a plurality of data created by a user and playback information comprising a play time and a display location of the data of the designated file, storing the designated file in a storage device through an interface provided by a first player, and the first player displaying each data in the designated file according to the corresponding play time and the display location indicated by the playback information while playing the multimedia film simultaneously. The data in the designated file is only displayed while the multimedia film is played, making no substantial change to the multimedia file itself.

### BACKGROUND OF THE INVENTION

1. Field of the Invention

The present invention relates to an audio/video (AV) playback method for a multimedia interactive mechanism, and more particularly, to an AV playback method capable of reading or downloading a designated file through a network mechanism.

2. Description of the Prior Art

With high demand for HD digital multimedia content, ten percent of families now have HD televisions, and that number is expected to grow to more than thirty percent over the next three years. Therefore, Hollywood moviemakers are beginning to put out movies in HD quality, with DVD as the primary storage medium. Moreover, the 4.7 GB capacity of the DVD makes it very hard to satisfy the storage requirements of multimedia in the future, such that the DVD is being replaced by next generation media, such as a High Definition DVD (HD DVD) and a Blu-ray Disc (BD). The huge demand for multimedia is attracting global technology companies to research DVD specs for the next generation, with hopes of providing customers with larger storage capacity to enjoy higher definition multimedia products.

Please refer to FIG. 1, which illustrates a schematic diagram of a player in the prior art. The player 10 comprises a reading unit 12, a storage device 14, and a playing unit 16. The reading unit 12 is utilized for reading a multimedia film stored in a DVD 18, such as a High Definition DVD (HD DVD) or a Blu-ray Disc (BD). The storage device 14 coupled to the reading unit 12 comprises a storage area 141 for storing the multimedia film. The playing unit 16 coupled to the storage device 14 is utilized for playing the multimedia film. The storage device 14 is a hard disc drive or a flash memory. The player 10 is a computer system comprising a player software installed therein.

According to the HD DVD spec, data for advanced content is stored in the storage device 14, and different multimedia films are stored in different locations, respectively, according to different provider ID and different content ID. As the advanced contents begin to execute, a player will choose the highest number on the playlist from the DVD or the storage device. The playlist uses HDi (High Definition Interactive) language to control the display method and playback behavior of the multimedia films. However, the original player can only allow users to view the multimedia films stored in the storage media, and cannot provide further interactive mechanisms since the multimedia films are readable only. For example, the player cannot provide users with the ability to create or modify recordings, add subtitles, change length of the film, or add movie reviews for a film; currently, such editing can be done by a separate editing software, and the multimedia films have to be copied and stored in the hard drive before editing the film. The subtitle or image is then directly applied on to the multimedia films through the editing software, and the final file is a new multimedia file. However, this final multimedia file is not sharable since these multimedia films are copyright-protected. Moreover, users cannot share or distribute their homemade recordings, subtitles, or movie reviews with other users since these data are included in the new multimedia file. Therefore, the pleasure of watching and modifying multimedia films is not shareable.

### SUMMARY OF THE INVENTION

It is therefore a primary objective of the present invention to provide an AV playback method for a multimedia interactive mechanism for solving problems in the prior art.

The present invention discloses an AV playback method for achieving multimedia interactive mechanism. The AV playback method comprises generating a designated file comprising a plurality of data created by a user and playback information comprising a playtime and a display location of the data of the designated file; storing the designated file in a storage device through an interface provided by a first player, and the first player displays each data in the designated file according to the corresponding play time and the display location indicated by the playback information while playing the multimedia film simultaneously.

Another purpose of the present invention is to provide an apparatus with a multimedia interactive mechanism for solving problems in the prior art.

The present invention discloses an apparatus with multimedia interactive mechanism. The apparatus comprises a reading unit for reading a multimedia film; a storage device coupled to the reading unit comprising a first storage area for storing the multimedia film; a second storage area for storing a designated file comprising a plurality of data and a playback information; and a playing unit coupled to the storage device for playing the multimedia film and the designated file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional player.

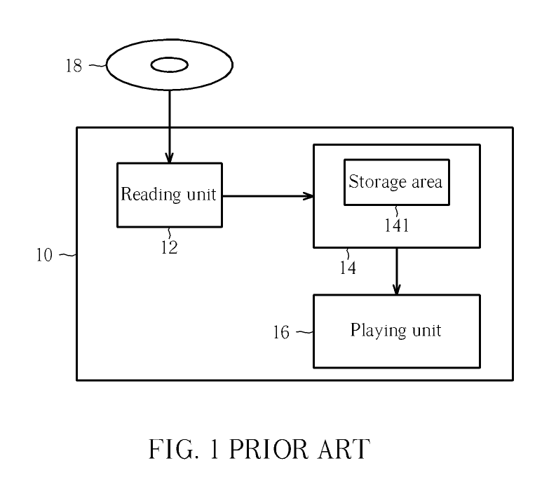

FIG. 2 illustrates a flow chart of an embodiment of an AV playback method for a multimedia interactive mechanism.

FIG. 3 illustrates a schematic diagram of a player according to the embodiment of the flow chart shown in FIG. 2.

FIG. 4 illustrates a flow chart of another embodiment of an AV playback method for a multimedia interactive mechanism.

FIG. 5 illustrates a schematic diagram of a player according to the embodiment of the flow chart shown in FIG. 4.

FIG. 6 illustrates a flow chart of another embodiment of an AV playback method for a multimedia interactive mechanism.

### DETAILED DESCRIPTION

The apparatus of the present invention is capable of combining a designated file with a multimedia film, such as movies, of any optical disc, such as HD DVD and Blu-ray Disc (BD) or any broadcasted TV program. Note that the multimedia film may be a copyright-protected film, which is illegal to be modified or uploaded to the Internet for sharing with others. The designated file comprises at least one data such as image data, audio data, text data, or at least one program, such as users' film reviews, homemade notes, figures, or HDi programs, and etc. The homemade data are the data made by users. The program can be Java, Java script, HDi program and the like. When the program is executed at its display time, it may show an animation, run a game, execute a calculation or change current playback (e.g. speed or scenes sequence). The actual functions in the program will be defined by users' implementation. Users can store the homemade data in a storage device of the multimedia film. The apparatus further creates a playback information, to indicate the display time and location to simultaneously display the data (such as the homemade data) in the designated file and the multimedia film.

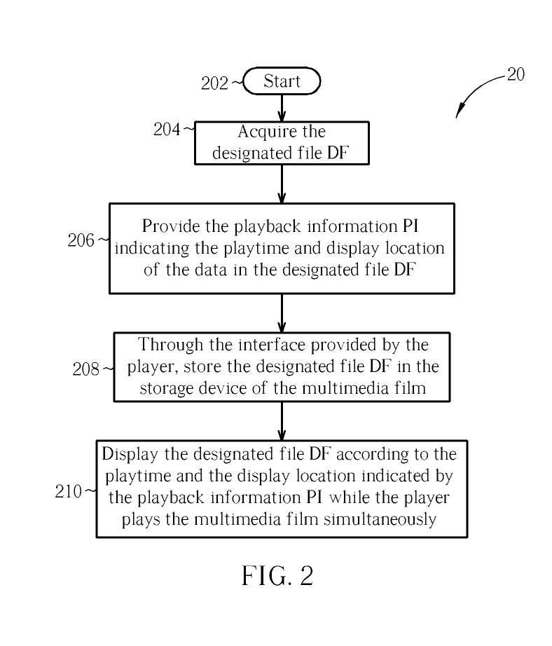

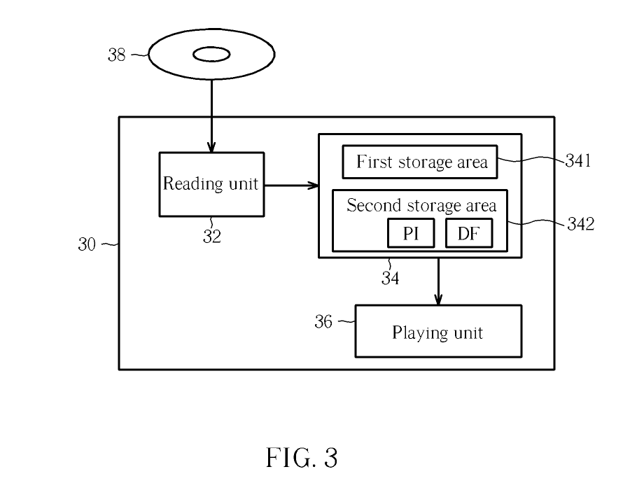

Please refer to FIG. 2 and FIG. 3. FIG. 2 illustrates a flow chart 20 of an embodiment of an AV playback method for a multimedia interactive mechanism. FIG. 3 illustrates a schematic diagram of a player 30 according to the embodiment of the flow chart 20 shown in FIG. 2. As shown in FIG. 3, the apparatus or player 30, such as a PC or notebook or any other electronic device, comprises a reading unit 32 a storage device 34, and a playing unit 36 such as a BD, HD-DVD, DVD playback program. The reading unit 32, such as an optical disc device, is utilized for reading the multimedia film stored in the DVD 38, such as a High Definition DVD (HD DVD) or a Blu-ray Disc (BD). The storage device 34 coupled to the reading unit 32 comprises the first storage area 341 and the second storage area 342. The multimedia film is read and decoded by the reading unit 32 and stored in the first storage area 341. The second storage area 342 may be utilized for storing a designated file DF and a playback information PI. The second storage 342 can be any portable device or other storage device. The playback information PI comprising a playlist indicating a playing sequence of the multimedia film may indicate the playtime and the display location. Please note that the playback information PI can be a form of a table or a playlist. The display location is the position where the data of the designated file DF is shown on the multimedia film. In other words, the display location of the data of the designated file DF corresponds to the location of the multimedia film. The second storage area 342 is for storing the DF and PI.

The playing unit 36 is coupled to the storage device 34 for playing the multimedia film and the designated file DF. The player 30 may display the designated file DF according to the playtime and the display location indicated by the playback information PI while playing the multimedia film simultaneously.

In the present embodiment, the storage device 34 can be a hard disk, a flash memory, an external hard disk drive, a network-attached storage device, or another kind of storage device. The playing unit 36 of the player 30 can be a player software installed in a computer system, such as PowerDVD, which is a playback software program with editing feature on the market. Note, the multimedia film is not limited to multimedia films stored in the DVD. For example, an AV file in the storage media may also be one of the embodiments. Note that the playback information PI may be stored outside the DVD, for example, in the second storage area 342 installed in the storage device 34, whereas the multimedia film may be stored in the DVD. FIG. 2 illustrates a flow chart of an embodiment of an AV playback method for a multimedia interactive mechanism. In Step 204, the designated file DF is generated or provided by users. The designated file DF can be data such as image data, audio data, text data or a program (e.g. Java or Java Script), such as a user's film review, a homemade note, a figure, or an HDi program, and etc. In Step 206, the playback information PI may be utilized for indicating the playtime and the display location of the data in the designated file. That is, the playback information indicates when the designated file DF appears and where the visual DF, such as image data and video data, is shown on the frame of the multimedia film. The display location can be any kinds of representing ways, such as which period of a film that a film reviews can be broadcasted in, which time of a film a background music can be arranged for, or which place of an image a subtitle can be shown on. Then, the designated file DF may be stored in the storage device 34 of the multimedia film, for example, the second storage area 342 shown in FIG. 3. In Step 210, because the first storage area 341 of the storage media 34 may be utilized for storing the multimedia film, and the second storage area 342 is utilized for storing the designated file DF and the playback information PI, the player 30 may display the designated file DF according to the playtime and the display location indicated by the playback information PI while playing the multimedia film simultaneously. Thus, when user acquires the designated file DF and has a software program of the invention installed in a PC or notebook, the player 30 can display the data such as image, subtitle, or voice from the designated file DF while displaying the original copyright protected content of the multimedia film.

Note that, the above-mentioned designated file DF can include a film review, a note, a figure, or an HDi program, and etc. The above example is just utilized for illustrating one of the embodiments of present invention, not for limiting conditions of the present invention. The specs of the High Definition DVD (HD DVD) or the Blu-ray Disc (BD) are well known for those skilled in the art and will not be described in detail. And, the flow chart 20 shown in FIG. 2 is just a practicable embodiment, not limiting conditions of the present invention.

Furthermore, the above-mentioned method and apparatus provide an interactive mechanism for users to watch the multimedia film while displaying the designated file DF, and the user can modify, edit, add, or reduce the contents of the multimedia film. But, the designated file DF is only executed while the multimedia film displays simultaneously, making no substantial change to the original multimedia film itself, i.e. editing without authoring.

The above embodiment may be applicable to various exemplary applications hereinafter.

In the first application, the designated file DF can include a users' film review. In Step 204, the film reviews may be generated by a user or acquired from other users. In Step 206, the playback information PI indicating the playtime and the display location of the data in the designated file DF may be predetermined, for example, if the playtime and location are predefined at the end of the film, the film reviews are displayed at the end of the film. Then, in Step 208, the film reviews may be stored in the storage media 34 of the multimedia film. In Step 210, the film reviews may be displayed on the multimedia film according to the playtime and display location indicated by the playback information PI while the player 30 may display the multimedia film simultaneously. At that time, users can watch not only the multimedia film, but also the related film reviews of the multimedia film while watching the multimedia film. Please note that, the original content of the multimedia film is not modified, i.e. the player 30 shows the edited result displaying film review without authoring the original content.

In the second application, the designated file DF can include a homemade incidental music. In Step 204, the homemade incidental music may be generated by users or acquired from other users. In Step 206, the playback information PI indicating the playtime and the play location of the incidental music of the multimedia film may be predetermined, for example, different incidental music are predefined to be played in different scenes and playtime (or play period) of each incidental music is marked according to the scenes of the multimedia film. Then, in Step 208, the designated file DF comprising the incidental music can be stored in the storage device 34 of the multimedia film. Finally, in Step 210, the incidental music may be played in the multimedia film according to the playtime, while the player 30 simultaneously may play the multimedia film. At that time, not only users can watch the multimedia film, but they can also listen to his or her own incidental music for the multimedia film simultaneously. Please note that, the original content of the multimedia film is not modified, i.e. the player 30 shows the edited result with different music without authoring the original content.

In the third kind of application, the designated file DF includes homemade subtitles. In Step 204, the homemade subtitles may be generated by users or acquired from other users. In Step 206, the playback information PI indicating the playtime and the display location of the subtitle of the multimedia film may be predetermined, for example, Chinese subtitles are displayed at the lowest side of the multimedia film and the playtime of the Chinese subtitles is predefined according to different scenes. The subtitles can be made up by the user and varied from the original dialogue of the multimedia film. Then, in Step 208, the Chinese subtitles may be stored in the storage device 34. And, in Step 210, the Chinese subtitles may be displayed in the multimedia film according to the designated playtime and display location. At that time, not only users can watch the multimedia film, but also see the Chinese subtitles while watching the multimedia film. Please note that, the original content of the multimedia film is not modified, i.e. the player 30 shows the edited result with homemade subtitles without authoring the original content.

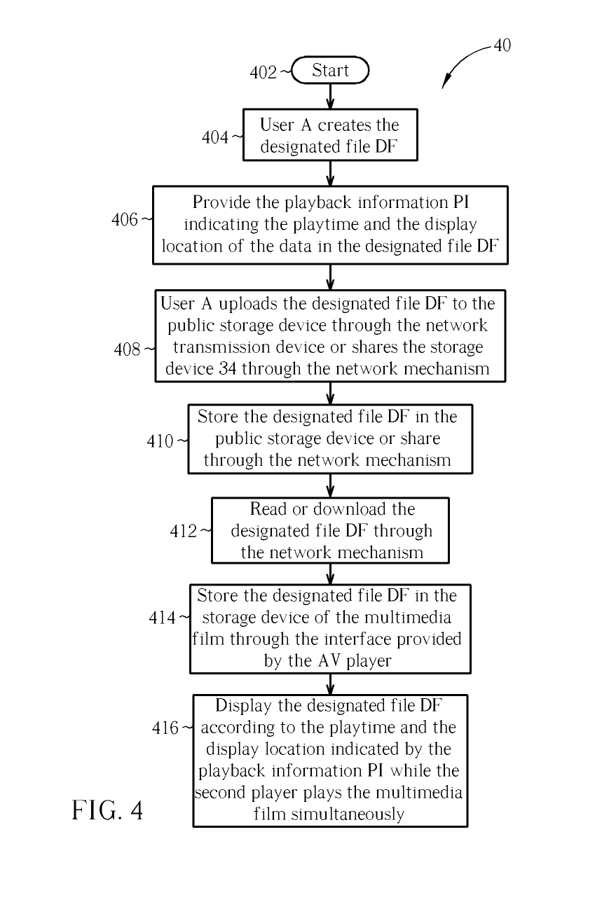

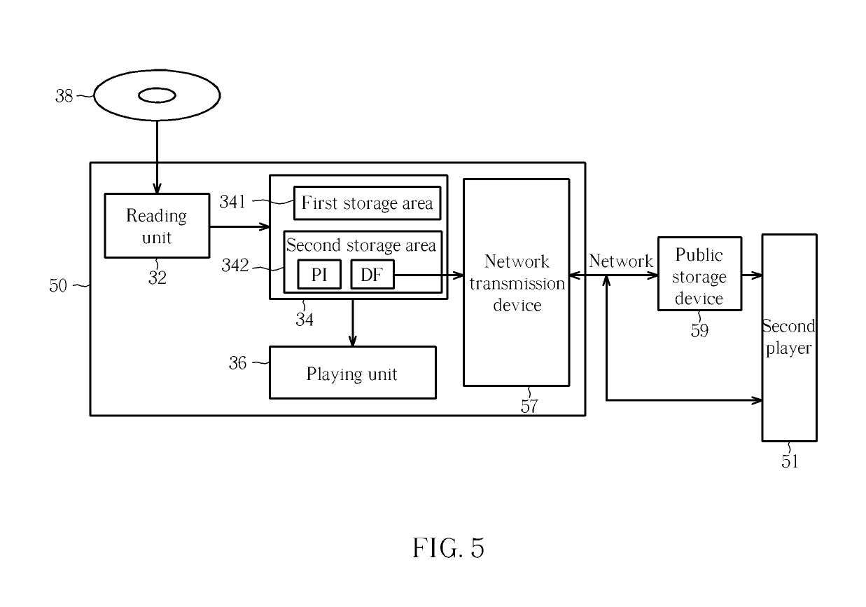

Please refer to FIG. 4 and FIG. 5. FIG. 4 illustrates a schematic diagram of a flow chat 40 of another embodiment of an AV playback method for a multimedia interactive mechanism. FIG. 5 illustrates a schematic diagram of an AV player 50 according to an embodiment of the flow chart 40 shown in FIG. 4. As shown in FIG. 5, the AV player or apparatus 50 comprises a reading unit 32, a storage media 34, a playing unit 36, and a network transmission device 57. The element symbols of the second embodiment and the first embodiment (the player 30) are the same, it represents that the elements have similar function or relative location, and detailed description thereof is not described again. The network transmission device 57 of the player 50 may be utilized for connecting to a network so that the AV player 50 can upload the designated file DF to a public storage device 59 or share the designated file DF through the network mechanism such as P2P, Bluetooth, and etc.

In the second embodiment, the AV player 50 may share the designated file DF with other users through the network transmission device 57. For example, a user A may upload the designated file DF to the public storage device 59 or a server, and a user B may download and store the designated file DF to the second player 51 such as a personal computer through the network. Otherwise, the user A may share storage, which stores the designated file DF in the network neighborhood, for example, the second storage area 342 shown in FIG. 5, and the user B may directly read the designated file DF from the second storage area 342 of the user A through the P2P mechanism. Please note that the embodiment does not limit to P2P mechanism, another example of network may be a blue-tooth mechanism.

As shown in FIG. 4, initially, the designated file DF may be created by the user A. However, the designated file DF can be provided to the user B through a network mechanism, or the user A can download the designated file DF through the network. The playback information PI indicating the playtime, meaning a time for play, and the display location of the data in the designated file DF may be provided in Step 406. The display location can be any kinds of representing ways, such as which period of a film that a film reviews can be broadcasted in, which time of a film a background music can be arranged for, or which place of an image a subtitle can be shown on. From Step 408 to Step 410, the user A can upload the designated file DF to the public storage device 59 through the network transmission device 57. Then, the designated file DF may be stored in the public storage device 59 or shared through the network. In Step 412, other users, like the user B or the user A of another computer, can download or store the designated file DF to the second AV player 51 such as a personal computer through network. On the other hand, the user A can share the second storage area 342, which stores the designated file DF. Then, other users can read the designated file DF directly from the second storage area 342 of the user A through the P2P mechanism. From Step 414 to Step 416, the other users may store the designated file DF in the storage device of the multimedia film through the interface provided by the second AV player 51, and may display the designated file DF according to the playtime and the display location indicated by the playback information while the second player displays the multimedia film simultaneously.

Note that, the flow chart 40 shown in FIG. 4 is just a practicable embodiment, not limiting conditions of the present invention. And, the order of the flow chart 40 represents a superior embodiment of the methods of the present invention. The order of steps can be changed based on the conditions, and is not limited to the above-mentioned order. For example, Step 412 and Step 414 can be combined into one step. Moreover, the player 50 in this embodiment is just a schematic diagram according to the embodiment of the flow chart 40 shown in FIG. 4, does not limit practical applications of the present invention.

Furthermore, the above-mentioned method and apparatus provide an interactive mechanism for users to watch the multimedia film (while displaying the designated file DF), and the user can see extra modifying, editing, adding, or reducing of the contents of the multimedia film. But, it only happens while the multimedia film displays simultaneously, making no substantial change to the original multimedia film itself, i.e. editing without authoring.

The above embodiment may be applicable to various exemplary applications hereinafter.

In the fourth application, the designated file DF includes a user's film review. In Step 404, the film review may be generated by the user A. In Step 406, the playback information PI may be provided or predetermined by the user A. The playback information PI may indicate the playtime and the display location of the film review of the multimedia film, for example, the display location of the film review is located at the lowest side of the film. Then, the user A may upload the homemade film review to the public storage device 59, such as a webpage, through the network transmission device 57 or share the storage device 34 through the network in Step 408. And, the designated file DF may be stored in the public storage device 59 or shared through the network in Step 410. Then, other users, like the user B or the user A of another computer, can search, read, or download the film reviews made by the user A through the network mechanism for watching the same multimedia film in Step 412 and store the film review in the storage device (the second player 51) of the multimedia film in Step 414. Finally, the film review may be displayed in accordance with the multimedia film according to the playtime and the display location when the second player 51 plays the multimedia film simultaneously in Step 416. Accordingly, the user A can not only watches the multimedia film with his or her homemade film review, but can also share the film review with other users through the network. Please note that, the original content of the multimedia film is not modified when the other users download the film review, i.e. the player 51 shows the edited result displaying the user A's film review without authoring the original content.

In the fifth application, the designated file DF includes a homemade incidental music. In Step 404, the incidental music may be created by the user A. In Step 406, the playback information PI may be provided or predetermined by the user A. The playback information PI may indicate the playtime of the incidental music of the multimedia film, for example, different incidental music are predefined to be played in different scenes, and the playtime of each incidental music is marked according to the scenes of the multimedia film. Then, the user A may upload the designated file DF comprising the homemade incidental music to the public storage device 59 through the network transmission device 57 or share the storage device 34 through the network in Step 408. And, the designated file DF may be stored in the public storage device 59, such as a webpage, or shared through the network in Step 410. Then, other users, such as the user B or another computer of the user A, can search, read, or download the incidental music made by the user A through the network mechanism for watching the multimedia film in Step 412, and store the incidental music in the storage device (the second player 51) of the multimedia film in Step 414. Finally, the incidental music may be played in the multimedia film according to the playtime when the second player 51 plays the multimedia film simultaneously in Step 416. Accordingly, the user A can not only listen to the homemade incidental music, but can also share the designated file DF comprising the incidental music with other users through the network. Thus, when the user plays the multimedia film with the designated file comprising an incident music by the playing unit 36 of the player 50, i.e., the playing unit 36 is installed in the user's PC or notebook, the music of the original film is changed according to the designated file DF without modifying the original copyright-protected content of the multimedia film.

In the sixth application, the designated file DF is the homemade subtitle. In Step 404, the Chinese subtitles may be created by the user A. In Step 406, the playback information PI may be provided by the user A. The playback information PI may indicate the playtime and the display location of the subtitles of the multimedia film; for example, the Chinese subtitle is displayed at the lowest side of the multimedia film and the playtime of the Chinese subtitle is predefined according to different scenes; for example, the subtitle is shown at time t1, t2, and t3. The subtitles can be made up by the user and varied from the original dialogue of the multimedia film. Then, the user A may upload the homemade Chinese subtitles to the public storage device 59 through the network transmission device 57 or share the storage media 34 through the network in Step 408. And, the designated file DF may be stored in the public storage device 59, such as a webpage (moovielive.com), or shared through the other network, such as P2P mechanism in Step 410. Then, other users like the user B or the user A of another computer can search, read, or download the Chinese subtitles made by the user A through the network mechanism for watching the same multimedia film in Step 412, and store the Chinese subtitles in the storage device (of the second player 51) of the multimedia film in Step 414. Finally, the Chinese subtitles may be displayed in the multimedia film according to the playtime and display location when the second player 51 plays the multimedia film simultaneously in Step 416. Accordingly, the user A can not only watch the homemade Chinese subtitles, but can also share with other users through the network. Thus, when user acquires the designated file DF and has a software program of the invention installed in a PC or notebook, the player 50 can display the image, subtitle, voice, or background music in the designated file DF while displaying the original copyright-protected content of the multimedia film.

The playback information of the designated file DF does not have to indicate both the playtime and the display location. In other words, if the designated file comprising the playback information is not displayed when playing the original multimedia film simultaneously, that may only affect the playback information of a playing sequence of the multimedia film.

In the seventh application, the designated file DF only comprises the playback information of a playing sequence of the multimedia film and does not comprise the designated file displayed when playing the original multimedia film simultaneously. In Step 404, the playback information may be created by the user A. In Step 406, the playback information PI may be provided by users. The playback information PI can change a playing sequence of the multimedia film to present the story of the film in another way, and thus, the script of the film can be rewritten. For example, the multimedia film comprises N scenes, and the multimedia film is played in reverse (starting from the Nth scene). Then, the user A may upload the homemade playback information to the public storage device 59 through the network transmission device 57 or share the storage device 34 through the network in Step 408. And, the designated file DF may be stored in the public storage device 59 or shared through the network in Step 410. Then, other users like the user B or the user A of another computer can search, read, or download the playback information made by the user A through the network mechanism for watching the multimedia film in Step 412 and store the playback information in the storage device (the second player 51) of the multimedia film in Step 414. Finally, the multimedia film may be displayed in a reverse order according to the playback information when the second player 51 plays the multimedia film simultaneously in Step 416. Accordingly, the user A can not only watch the multimedia film displayed in a reverse order, but can also share the playback information with other users through the network.

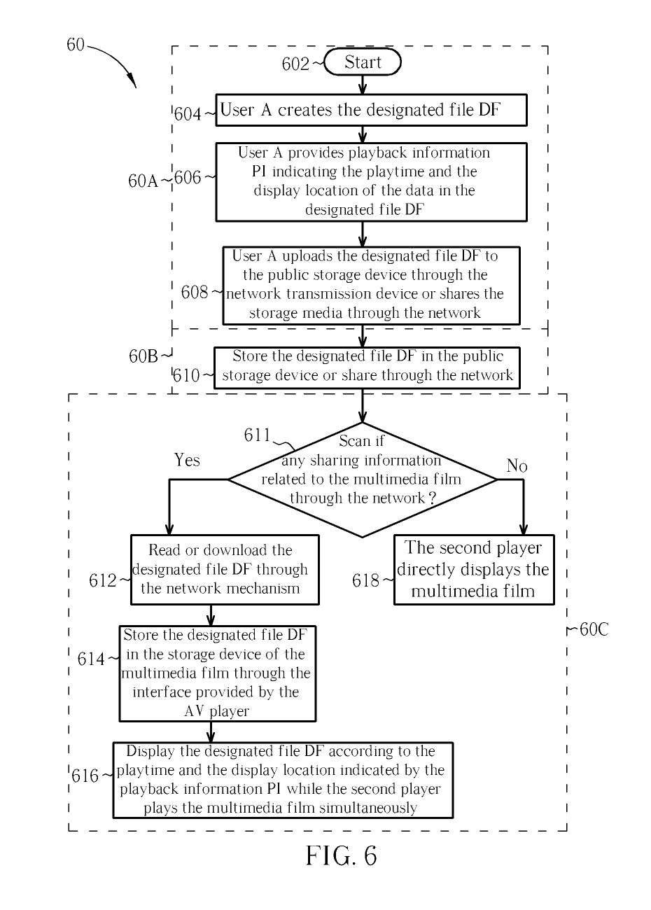

Please refer to FIG. 6. FIG. 6 illustrates a schematic diagram of a flow chart 60 of an AV playback method for a multimedia interactive mechanism according to the third embodiment of the present invention. The steps of the flow chart 60 comprise a first stage 60A, a second stage 60B, and a third stage 60C.

The first stage 60A comprises the step of uploading a creation, which comprises the following steps:

Step 602: Start the flow chart.

Step 604: User A creates the designated file DF.

Step 606: User A provides playback information PI indicating the playtime and the display location of the data in the designated file DF.

Step 608: User A uploads the designated file DF to the public storage device 59 through the network transmission device 57 or shares the storage media 34 through the network such as P2P mechanism.

The second stage 60B comprises a sharing step, which comprises the following steps:

Step 610: Store the designated file DF in the public storage device 59 or share through the network.

The third stage 60C comprises the step of downloading for use, which comprises the following steps:

Step 611: Scan sharing information related to the multimedia film through the network. If the sharing information related to the multimedia film exists, execute Step 612. Otherwise, execute Step 618.

Step 612: Read or download the designated file DF through the network mechanism.

Step 614: Store the designated file DF in the storage device of the multimedia film through the interface provided by the AV player 51.

Step 616: Display the designated file DF according to the playtime and the display location indicated by the playback information PI while the second player plays the multimedia film simultaneously.

Step 618: The second player directly displays the multimedia film.

The flow chart 60 shown in FIG. 6 is a modifiable embodiment of the flow chart 40 shown in the FIG. 4. Please refer to FIG. 5 in comparison with FIG. 4. In the first stage 60A, the designated file DF is created by the user A in Steps 604, 606, and 608. In the second stage 60B, the designated file DF may be stored in the public storage device, as in Step 610. In the third stage 60C, other users can download the designated file DF for use, for example, the user A or the user B download the designated file DF from another computer through the network. For example, the user A and the user B may all be in the same group, and the user A can give authority for the user B to use the designated file DF. Because the user A can upload the designated file DF to the public storage device 59 through the network transmission device 57 in Step 608, the designated file DF may be stored in the public storage device 59 or shared through the network such as P2P mechanism. Before the user B (or other users) wants to watch the multimedia film, the second player 51 can scan sharing information related to the multimedia film through the network. If the sharing information related to the multimedia film exists, the user B or other users can download and store the designated file DF in the second player 51 on personal computers through servers. On the other hand, the user A can also share the second storage area 342, which stores the designated file DF in the network. Before the user B or other users watch the multimedia film, the second player 51 can scan the sharing information related to the multimedia film through the network. If the sharing information related to the same multimedia film exists, the user B or other users can directly read the designated file DF from the second storage area 342 of the user A through the P2P mechanism in Step 611 and Step 612. Finally, the user B or other users may store the designated file DF in the storage device through the interface provided by the second player 51. Then the second player 51 displays the designated file DF according to the playtime and the display location indicated by the playback information while displaying the multimedia film simultaneously from Step 614 to Step 616. If no sharing information exists related to the multimedia film, the second player 51 may directly display the multimedia film in Step 618.

Please note that uploading the creation in the first stage 60A represents that the designated file DF can be uploaded by the user A. Sharing in the second stage represents that the designated file DF may be stored in the public storage device. Downloading for use in the third stage 60A represents that other users can download the designated file DF to use through any network mechanism. The scope from the first area 60A to the third area 60C is not limited to sequential steps. In other words, a certain user uploading the designated file DF and another user downloading the designated file DF for use are not limited to happening sequentially. Another user also may not detect any designated file DF related to the multimedia film when scanning the sharing information related to the multimedia film (there is no user that has uploaded the related designated file DF until now). As shown in Step 618, the multimedia film may be displayed directly. Therefore, uploading the creation in the first stage 60A and downloading for use in the third stage 60C are connected in a non-sequentially-limited manner by sharing in the second stage 60B.

The above embodiments are only utilized for illustrating the present invention, and not limiting upon the category of the present invention. The disk 38 mentioned above is not limited to a high definition digital versatile disc (HD DVD) or a Blu-ray disc (BD). The method of the present invention may be extended to disks of the next generation. The multimedia film may be a disk or an AV file in the storage device. Furthermore, the playback information PI may be outside the disk (e.g. the second storage area 342 stored in the storage device 34) if the multimedia film is stored in the disk. The storage device 34 can be a hard disc drive, a flash memory, an external disk, or a network disk, but is not limited here. Other kinds of storage devices can also be used. The designated file DF can be film reviews, notes, figures, or HDi programs, etc, but are also not limiting conditions of the present invention. Otherwise, the flow chart 20, the flow chat 40, and the flow chart 60 are simply practicable embodiments of the present invention, and not limiting conditions of the present invention. And, the sequence of steps can be changed based on the conditions, and is not limited to the above-mentioned sequence.

In addition, not all HDi or Java interactive mechanisms in the HDDVD or BD disc are designed well and the functions are not satisfying users' demand sometimes. Users only can receive and use what studios provide. For example, in some HDDVD and BD discs, the HDi or BDJ interactive mechanisms are only designed for CE player users, so the mouse behaviors are not defined in these movie titles. Therefore, the PC player users only can use keyboard to manipulate the interaction in the movies, for example, button selection, configuration setting of this movie, etc.

Otherwise, user can write and add new functions for these movies to refine their interaction and share to other further. For example, the designated file may further include a HDi script, which defines the mouse handle for a movie may be generated by user A. According to the playback information PI provided by user A, the time to run the HDi script is indicated. Then, another PC user B can download the mouse handle made by user A through the network mechanism for watching the same multimedia film. Finally, the script may be run in accordance with the multimedia film according to the playtime when User B plays the multimedia film simultaneously. And then User B can use mouse to reach the interaction defined by User A. Accordingly, the user A can not only watches the multimedia film by using his or her mouse handle but can also share the handle with other users through the network.

In summary, the present invention provides an AV playback method for a multimedia interactive mechanism and related AV players. Through the method and device disclosed through the present invention, users can combine homemade files with a multimedia film. For example, the film reviews, notes, figures, or HDi programs for the multimedia film may be stored in the storage device 34, and the homemade data may be displayed according to the playback information. Further, the homemade file may be shared with different users through the network mechanism. Therefore, the present invention can promote increased viewers of the multimedia film by providing users with means for sharing their experiences and creativity. The applications of the present invention are widespread. For example, users can make incidental music, add subtitles for the multimedia film, present a new movie by rearranging display order of the scenes in the film and use the multimedia film for auxiliary teaching (e.g. filling in the subtitles or dictation). Therefore, the disclosed method and device of the present invention can add contents, which the original multimedia film does not have, and display the contents by combining them with the multimedia film. Moreover, a user can download new elements through the network to add new functions, which the original program (player) does not have.

Those skilled in the art will readily observe that numerous modifications and alterations of the device and method may be made while retaining the teachings of the invention.

What is claimed is:

1. An AV playback method for an interactive operation function, comprising:
generating a designated file comprising a plurality of data created by a user and playback information comprising a play time and a display location of the data of the designated file corresponding to the location of a multimedia film;
storing the designated file in a storage device through an interface provided by a first player; and
the first player displaying each data in the designated file according to the corresponding play time and the display location indicated by the playback information while playing the multimedia film simultaneously, making no substantial change to the multimedia film itself.

2. The AV playback method of claim 1, further comprising:
uploading the designated file to a public storage device through a network transmission device.

3. The AV playback method of claim 2, further comprising:
utilizing the network transmission device for sharing the storage device that stores the designated file.

4. The AV playback method of claim 1, further comprising:
analyzing the multimedia film and determining the content thereof;
scanning the designated file in the public storage device; and
searching for the designated file related to the content of the multimedia film.

5. The AV playback method of claim 1, wherein the designated file is read or downloaded through a network mechanism.

6. The AV playback method of claim 5, further comprising:
storing the designated file in the storage device through an interface provided by a second player; and
the second player displaying the designated file according to the play time and the display location indicated by the playback information while playing the same multimedia film simultaneously.

7. The AV playback method of claim 1, wherein the designated file further comprises image data, video data, audio data, text data or programs.

8. The AV playback method of claim 7, wherein the programs comprise HDi program.

9. The AV playback method of claim 1, wherein the playback information comprises a playlist indicating a playing sequence of the multimedia film.

10. The AV playback method of claim 1, wherein the first player is a computer system comprising a player software.

11. The AV playback method of claim 1, wherein the multimedia film is stored in an optical storage device.

12. The AV playback method of claim 11, wherein the optical storage device is a digital versatile disc (DVD), a high definition digital versatile disc (HD DVD) or a blue-ray disc (BD).

13. The AV playback method of claim 12, wherein the playback information is stored outside the optical storage device.

14. The AV playback method of claim 1, wherein the multimedia film is a video file or a copyright protected file stored in the optical storage device.

15. The AV playback method of claim 1, wherein the multimedia film is a TV program broadcasted from a server.

16. An apparatus for a multimedia interactive mechanism, comprising:
a reading unit, for reading a multimedia film;
a storage device, coupled to the reading unit, the storage device comprising:
a first storage area, for storing the multimedia film;
a second storage area, for storing a designated file comprising a plurality of data and a playback information, wherein the playback information comprises a play time and a display location of the data of the designated file; and
a playing unit, coupled to the storage device, for playing the multimedia film and the designated file;
wherein the playing unit displays each data in the designated file according to the corresponding play time and the display location indicated by the playback information while playing the multimedia film simultaneously, making no substantially change to the multimedia film itself.

17. The apparatus of claim 16, further comprising:
a network transmission device, for connecting to a network;
wherein the player is able to upload the designated file to a public storage device by the network transmission device or share the storage device through the network.

18. The apparatus of claim 16, wherein the designated file comprises image data, video data, audio data, text data or programs.

19. The apparatus of claim 16, wherein the playback information comprises a playlist indicating a playing sequence of the multimedia film.

20. The apparatus of claim 16, wherein the apparatus is a computer system comprising a player software.

21. The apparatus of claim 16, wherein the multimedia film is stored in an optical storage device.

22. The apparatus of claim 21, wherein the optical storage device is a DVD, a high definition digital versatile disc or a blue-ray disc.

23. The apparatus of claim 22, wherein the playback information is stored outside the optical storage device.

24. The apparatus of claim 16, wherein the multimedia film is a video file, a copyright protected file, stored in the storage device.

25. The apparatus of claim 16, wherein the multimedia film is a TV program broadcasted from a server.
